(19) United States
(12) Patent Application Publication
(10) Pub. No.: US 2015/0180942 A1
(43) Pub. Date: Jun. 25, 2015

(54) MESSAGE-ORIENTED MIDDLEWARE

(71) Applicants: Kristian Kraljic, Bad Schoenborn (DE); Karsten Kalter, Wiesloch (DE); Stefan Vormbrock, Wiesloch (DE)

(72) Inventors: Kristian Kraljic, Bad Schoenborn (DE); Karsten Kalter, Wiesloch (DE); Stefan Vormbrock, Wiesloch (DE)

(73) Assignee: SAP AG, WALLDORF (DE)

(21) Appl. No.: 14/137,830

(22) Filed: Dec. 20, 2013

(51) Int. Cl. H04L 29/08

(52) U.S. Cl. CPC H04L 67/10

(57) ABSTRACT

Various embodiments herein each include at least one of systems, methods, and software providing a message-oriented middleware infrastructure to integrate messaging between entities, such as software systems, processes therein, and other elements that may be connected to a network. Such embodiments may include pushing messages directly to entities upon receipt of a message or storing a message in an inbox for later retrieval. Additionally, various embodiments handle both message format transformations and message target determinations thereby alleviating considerable efforts to customize each constituent, integrated entity through one or both of custom coding and configuration.

### BACKGROUND INFORMATION

In modern entities, processes are often supported by several different data processing systems. These systems may be procured from a single software development entity, but often times are procured from disparate software development entities. Regardless, data may be replicated between these systems and processes integrated. To facilitate this data and process integration between diverse software systems, software systems exchange messages. However, each software system is customized either to format messages for sending according to each of the other software systems or to read messages from each of the other systems. Additionally, each software system is customized to determine when messages need to be sent to each of the other software systems.

Such customization may be performed through manipulation of configuration settings, but often times the customization requires custom code development. Regardless, such code and configuration customization is performed in each software system with regard to each of the other software systems to be integrated. This leads to very high complexity in communication infrastructure between software systems and a very high distribution of redundant code. Adding a single system to a software system community often requires the adaption of all other integrated software systems. The complexity even increases if more than one internal/external system is involved in the business workflow process of a single message, because not only the data of the involved system has to be stored, every system needs to store data for every system involved to make sure the target determination is done correctly after processing the message in the respective system.

### BRIEF DESCRIPTION OF THE DRAWINGS

FIG. 1 is a logical block diagram of a computing environment, according to an example embodiment.

FIG. 2 is a logical block diagram of messages, according to various embodiments.

FIG. 3 is illustrates an example mapping between data models, according to an example embodiment.

FIG. 4 is a block flow diagram of a method of message processing, according to an example embodiment.

FIG. 5 is a block flow diagram of a method according to an example embodiment.

FIG. 6 is a block diagram of a computing device, according to an example embodiment.

### DETAILED DESCRIPTION

Various embodiments herein each include at least one of systems, methods, and software providing a message-oriented middleware infrastructure to integrate messaging between software systems. Such embodiments can push messages directly to software systems upon receipt of a message or store a message in an inbox for later retrieval. Additionally, various embodiments handle both message format transformations and message target determinations thereby alleviating considerable efforts to customize each constituent, integrated software system through one or both of custom coding and configuration. Instead, the message-oriented middleware, according to the embodiments herein is able to receive a message from a first software system, transform at least a portion of the message into a generic format according to a mapping between a message format of the first software system and the generic format, and store the transformed portion into an extract portion added to or stored in association with the received message. The message-oriented middleware may further transform the message form the generic format to a format of a second software system to which the message is to be sent, the transformation performed according to a mapping between a message format of the second software system and the generic format. The message-oriented middleware may then send the message to the second software system, either directly or by storing the message to an inbox of the second software system when the second software system communicates with the message-oriented middleware in an asynchronous manner. Additionally, once the received message, or a portion thereof, has been transformed into the generic format, one or more routing rules are identified based on the transformed portion of the message to identify one or more targets software systems to receive the message, such as the second software system. Through such embodiments, constituent, integrated software systems are customized only once to communicate with the message-oriented middleware and message target determination logic is added only once to the message-oriented middleware rather than to each of the constituent, integrated software systems. Additionally, messages communicated via the message-oriented middleware may be stored and logged in a central location allowing an implementing organization to track messages for problem solving, compliance monitoring, legal reasons, and other purposes. As a result, integration, maintenance, and monitoring efforts are greatly simplified, accelerated, and made much more economical.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

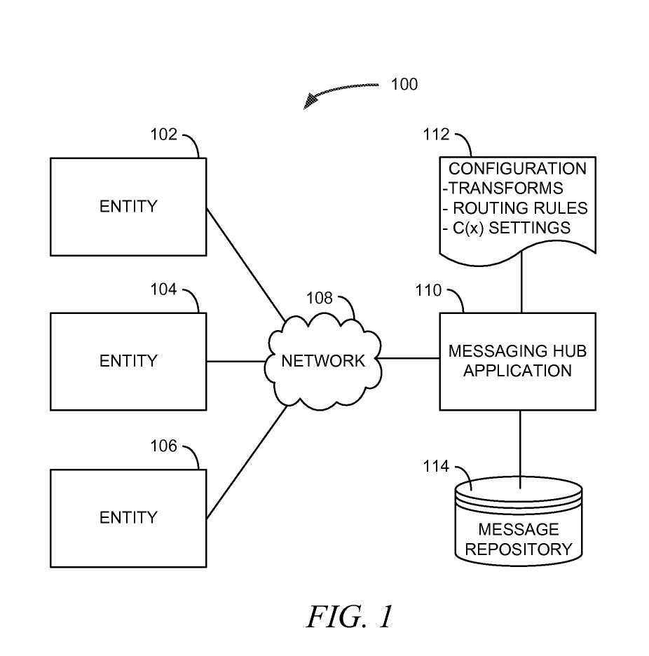

FIG. 1 is a logical block diagram of a computing environment 100, according to an example embodiment. The computing environment 100 includes entities 102, 104, and 106 connected to a network 108, such as one or both of a wired and wireless data network. Also connected to the network 108 is a messaging hub application 110 that provides message-oriented middleware functionality within the computing environment 100. The messaging hub application 110 executes in view of a configuration 112 and includes, or is connected to, a message repository 114.

The entities 102, 104, 106 are representative of elements that can communicate messages over the network 108. Such elements that can communicate messages over the network may include software systems, processes of software systems, objects of software systems, physical and virtual computing devices, networking equipment such as switches and routers, and other logical and physical entities within the computing environment. Additionally, although only the three entities 102, 104, 106 are illustrated, other numbers of entities may be present in different embodiments. Typically, there are at least two entities and there may be many entities, such as four or more, maybe even in the hundreds such as when processes and objects of software systems are message-enabled, whether that be to send or receive messages, or both sending and receiving messages over the network 108.

As mentioned above, the network 108 may be one or both of a wired and wireless network. The network 108 may provide data connectivity to one or more network types, such as a local area network, wide area network, the Internet, a virtual private network, a value added network, a system area network, a mesh network, and the like.

The messaging hub application 110 is typically deployed to a server-class computing device. The messaging hub application 110 operates to receive messages from entities 102, 104, 106 and transform received messages into a generic message format. The transformation is generally performed according to transformation rules defined for transforming messages between a format of a message sending entity 102, 104, 106 and a generic format of the messaging hub application 110. The transformation may be performed with regard to an entirety of a message or a portion thereof. In some embodiments, the transformation is performed with regard to a portion of the message and is stored to an extract portion of the message, which the messaging hub application 110 may add to a data structure of the message or may store to the message repository 114 in association with a copy of the message also stored to the message repository 114. The messaging hub application 110 may store an extract portion to the message repository 114 with regard to each transformed performed with regard to the message. However, in other embodiments, the messaging hub application 110 may store multiple copies of the message to the message repository 114, each copy including a unique transformed extract portion and each copy stored in an associated manner with all copies of the message.

The messaging hub application 110 may further identify one or more entities 102, 104, 106 or storage locations to which each message is to be routed. Once each entity to which the message is to be routed is identified, the messaging hub application 110 transforms the message to formats of the entities 102, 104, 106 or storage locations to which the each message is to be routed, and dispatches the messages accordingly. The messaging hub application 110 also stores a copy of each sent message, either as a unique message in an associated manner with related messages, such as the originally received message from which the message or messages are derived, or as elements within a larger message data structure that includes the originally sent message.

In some such embodiments, the messaging hub application 110 also logs each action taken with regard to a received message, including the generation and sending of one or more messages based thereon. The log is written to the message repository, such as to a log portion of a message data structure that is maintained with regard to each received and sent message.

The messaging hub application 110 typically executes according to a configuration 112. The configuration 112 typically includes data that sets messaging hub application 110 parameters and provides data transformation logic to transform messages or at least certain portions of message data between a format of an entity 102, 104, 106 and a central, generic format of the messaging hub application 110. The configuration 112 also typically includes routing rules. The routing rules are evaluated with regard to a received message to identify one or more applicable routing rules. For example, transformed data extracted from a received message may be evaluated to determine a source of the message and the contents thereof and routing rules may be identified based thereon. The routing rules, once identified, are then applied against the received message and one or more target entities or storage locations for the message may be identified. During application of the one or more identified routing rules may further identify one or more additional routing rules to be applied to the message. As such, routing rules may include conditional expressions, the application of which may identify no targets for where the message is to be routed, one target, multiple targets, and even one or more additional routing rules to be applied. The configuration 112 may also include connection settings that may be utilized in connecting with one or more entities 102, 104, 106, the network 108, the message repository 114, and other devices, systems, processes, and the like via the network 108.

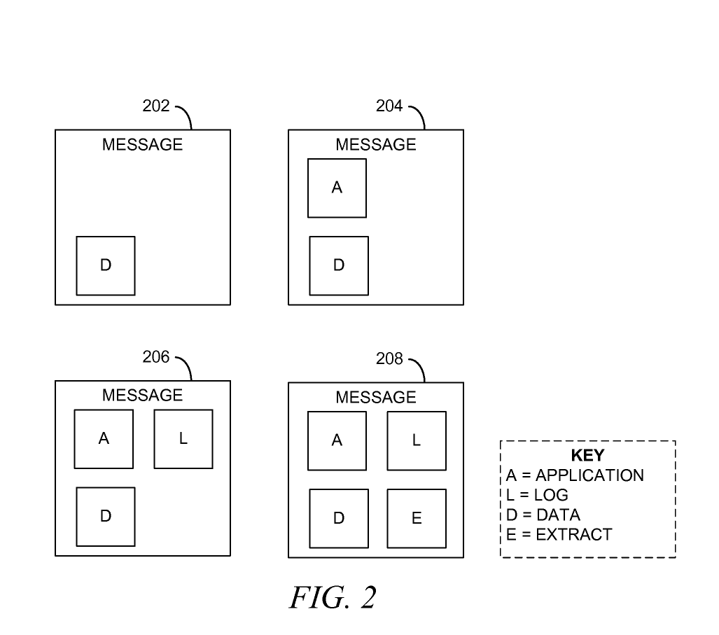

The message repository 114 is a storage location to which the messaging hub application 110 writes data with regard to received and transmitted messages. Additionally, the messaging hub application 110 writes data to the message repository representative of transformations applied to a received message, which may include different forms of message data. In some embodiments, each message is stored once and is augmented with one or more of transformation data, a log to which data representative of transformations applied, routing rules applied, messages generated and sent, and the like. FIG. 2 provides various example illustrations of messages that may be received, stored in the message repository, and transmitted via the network 108 to one or more targets identified through application of the routing rules of the configuration 112.

FIG. 2 is a logical block diagram of messages, according to various embodiments. The messages 202, 204, 206, 208 illustrated in FIG. 2 are logical example representations of how messages may be received, augmented, transformed, and sent. As illustrated, the messages 202, 204, 206, 208 may include four different portions. The portions include: 1) an application portion “A”; 2) a data portion “D”; 3) a log portion “L”; and 4) an extract portion “E”.

The application portion includes data identifying a source entity, such as a software system that generated a message. The data portion is the most basic portion of a message and a message may include only the data portion. The data portion is generally the data payload of a message. For example, the data payload may include data to be synchronized with other entities, function or method calls to other entities, data to be stored by other entities, process synchronization semaphores, and the like. Based on data included in the data portion, the messaging hub application 110 may generate the other portions of a message. For example, an application portion may not be included in a message, such as the message 202. However, the data portion or headers included in network protocol data of a message when received may include data identifying a source entity of the message. The messaging hub application 110 may extract such data and augment the received message with the application portion, such as is illustrated in message 204.

In some embodiments, the messaging hub application 110, as briefly described above, may log data processing activities performed with regard to a received message and with regard to sent messages. However, in most instances, a message that is sent is sent with regard to a received message and logging activity with regard to a sent message is also logging activity with regard to a received message. Log entries with regard to a message are made in the log portion of the message. The messaging hub application 110 may add a log portion directly within a data structure of a message, such as is illustrated with regard to message 206. However, in other embodiments, log entries may be made in a log table stored by the message repository 114.

Regardless, log entries, as described above, are made to record performed data processing activities performed with regard to a message. Such data processing activities and log entries may record an action, such as message received, extract portion generated and populated with data extracted from the message, data transformed, routing rule applied and an identifier of the particular rule, target entity identified and an identifier of the particular entity, message generated and sent to a particular entity, and the like. Some or all of such log entries may be accompanied by a date-time-stamp of when the data processing activity was performed or completed.

The extract portion includes data extracted from a received message, either initially upon receipt or at a later time as needed based on a particular data transform rule, routing rule, or other logical element. When data is extracted from a message by the messaging hub application, the data is then transformed according to one or more transform rules selected based on an entity that created the message. The entity that created the message may be determined based on data stored in the application portion of the message. The extracted and then transformed data is written by the messaging hub application 110 to the extract portion of the message. In some embodiments, when writing the data to the extract portion of the message, the messaging hub application 110 may first determine whether the extract portion is present in the message. When not present, the messaging hub application 110 may first generate the extract portion. However, in other embodiments, the extract portion may instead be stored in one or more tables of the message repository 114 in association with the message.

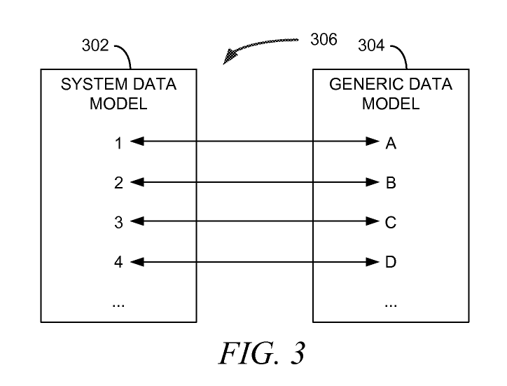

FIG. 3 is illustrates an example mapping 306 between data models 302, 304, according to an example embodiment. The mapping 306 is illustrated as a arrows between data elements 1, 2, 3, 4 of a system data model 302, such as a data model of one of the entities 102, 104, 106 of FIG. 1 and corresponding data elements A, B, C, D of a generic data model 304. The generic data model is, for example, a data model of the messaging hub application 110 of FIG. 1. The arrows of the mapping 306 are intended to reflect not only a mapping between data elements, but also data transformations that may be needed. For example, the system data model may include number data stored in a string format. The mapping 306 also accounts for such data-type transformations as may be defined. Additionally, although the illustration is a one-to-one set of mappings 306, one such mapping may include a mapping of one data element of the system data model 302 to two or more data elements of the generic data model 304, and vice versa. Such mappings 306 are present for each entity, such as the entities 102, 104, 106 of FIG. 1, that communicates messages via the messaging hub application 110.

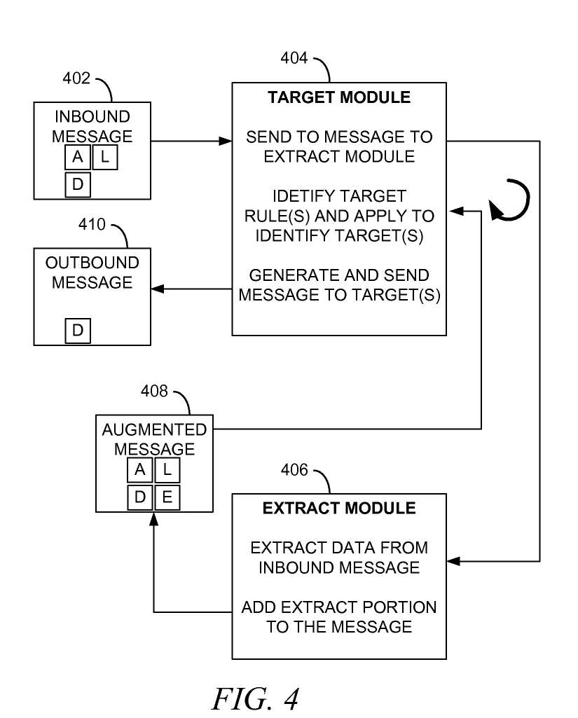

FIG. 4 is a block flow diagram of a method of message processing, according to an example embodiment. The example method illustrates how an inbound message 402 is processed in some embodiments to generate and send and outbound message 410. The method includes two data processing modules as may be present in a messaging hub application 110 of FIG. 1 in some embodiment. These modules include a target module 404 and an extract module 406.

The method illustrated in FIG. 4 begins with the target module 404 receiving an inbound message 402. As illustrated, the inbound message includes an application portion “A”, a data portion “D”, and a log portion “L”, as described above with regard to the messages 202, 204, 206, 208 of FIG. 2. The target module 404 may first log a data and time the message was received and then each of the subsequent data processing activities throughout the processing. The target module 404 then sends the inbound message 402 to the extract module 406. The extract module extracts data from the inbound message 402, performs any needed data transformations according to mappings defined between an application that generated the inbound message and a generic format of the messaging hub application, such as the mapping 306 illustrated and described with regard to FIG. 3. The extract module 406 then adds an extract portion to the received message and adds the extracted and transformed data thereto. The received message 402 is now in the form of augmented message 408. The extract module 406 returns the augmented message to the target module.

Data from one or both of the application portion and the data portion are then evaluated by the target module 404 to identify target rules to apply to the augmented message. Application of the target rules is performed to identify targets, such as one or more of the entities 102, 104, 106, to which the message, or a derivative thereof, is to be sent. Once the target rules to apply have been identified, the target rules are then applied. Some target rules may be applied in parallel while others may be identified for serial application, such as where the output of one target rule may be the input for one or more other target rules. Further, some target rules may identify one or more additional target rules to be applied. Application of the target rules may result in identification of one or more targets to which the message, or a message derived based thereon, is to be sent. In some embodiments, the log of the augmented message 408 is written to with an indication of the target rules that have been applied. In some such embodiments, a data transformation may be applied prior to or as part of application of a target rule.

Once a target is identified, the method of FIG. 4 may then generate and send a message to each of the identified targets in the form of one or more outbound messages 410. Each outbound message may be transmitted to its respective target via a network, via an inbox of a target that may be present in a message repository, or other data storage location, when the respective target connects in an asynchronous manner to a system performing the method of FIG. 4, or both. The message or data representative thereof may also be written to the log of the augmented message 408.

In some embodiments, the log provides a searchable record of messages received, processed, and sent by a system including the target module 404 and extract module and performing the method illustrated in FIG. 4. Data representative of the inbound message 402, augmented message 408, outbound message 410, and the processing and generation thereof is stored, such in the message repository 414 of FIG. 1. The stored log provides various capabilities serving a variety of purposes. For example, certain legal and regulatory requirements may impose burdens on system operators when processing certain types of data, such as data with regard to regulated industries, industries subject to national security scrutiny, financial services, insurance, data security, and the like. Additionally, certain organizational policies and industry best practices may require or suggest logging of such activity. The log may also provide additional benefits in the form of a data resource for locating and resolving system integration issues.

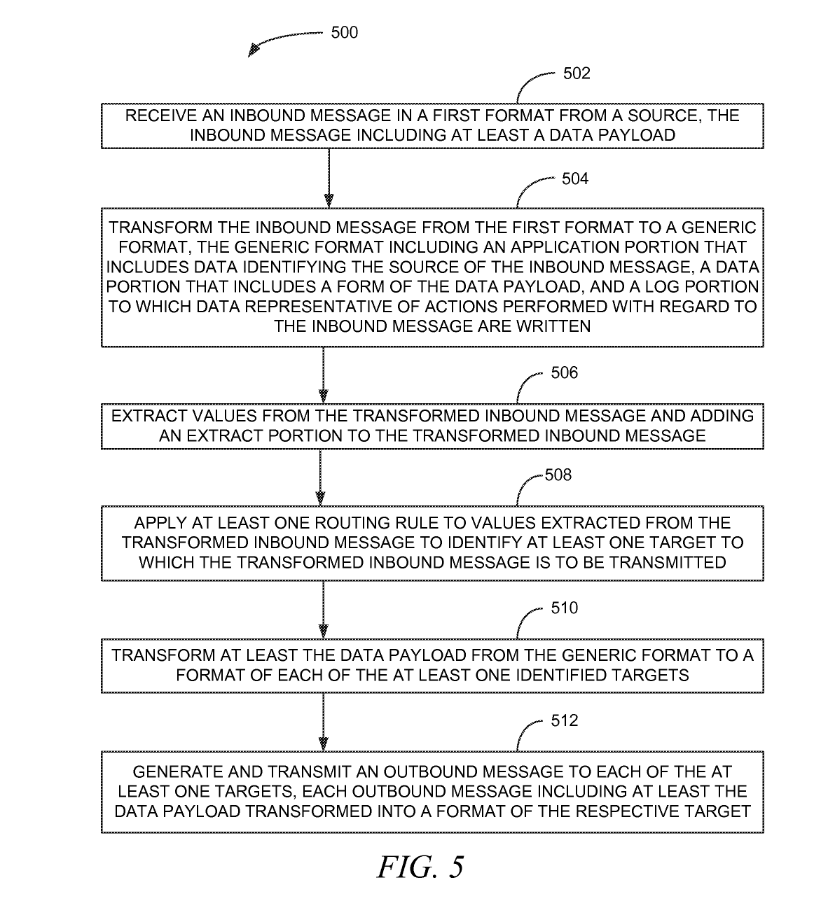

FIG. 5 is a block flow diagram of a method 500 according to an example embodiment. The method 500 is an example of a method for processing system and data integration messages from a first software system for possible distribution within a computing environment including a plurality of software systems.

In some embodiments, the example method 500 includes receiving 502, via a network, an inbound message in a first format from a source, the inbound message including at least a data payload. The source from which the message is received may be an entity as described previously herein. The method 500 further includes transforming 504 the inbound message from the first format to a generic format. The transforming 504 of the message may be a transformation of a portion of the message or an entirety. The generic format, in some embodiments, includes an application portion that includes data identifying the source of the inbound message, a data portion that includes a form of the data payload included in the received 502 message, and a log portion to which data representative of actions performed during performance of the method 500 with regard to the inbound message are written.

The method 500 may then continue by extracting 506 values from the transformed inbound message and adding an extract portion to the transformed inbound message. The extract portion added to the inbound message will typically include the extracted 506 values, but in some embodiments, may include additional data. The method 500 may then apply 508 at least one routing rule to one or more values extracted 506 from the transformed 504 inbound message to identify at least one target to which the transformed 504 inbound message is to be transmitted. Prior to generating and transmitting a message to the identified at least one target, the method 500 transforms 510 at least a portion of the data payload from the generic format to a format of each of the at least one identified targets to which the transformed inbound message is to be transmitted. The method 500 may then generate and transmit 512, via the network, an outbound message to each of the at least one targets, each outbound message including at least a portion of the data payload transformed into a format of the respective target.

In some embodiments of the method 500, each transform 504, 510 is performed according to a data transform model selected from a plurality of data transform models according to a source the inbound message is received from or a target to which an outbound message is to be sent. Each transform model in such embodiments typically includes at least a mapping between data items of the generic format and a format of a respective source or target, such as is illustrated and described with regard to FIG. 3.

In some embodiments of the method 500, applying 508 the at least one routing rule includes identifying at least two routing rules to apply based on at least one value extracted from the transformed 504 inbound message, such an identifier of one or both of a source and target of a received 502 inbound message and one or more data elements included within the data payload of the message. Such embodiments further include applying each of the at least two identified routing rules to at least one value extracted from the transformed 504 inbound message. Application of at least one of the two identified routing rules may cause application of at least one additional routing rule result in the identification of each of the at least one targets to which the transformed 504 inbound message it to be transmitted.

In some embodiments, a routing rule may include a conditional expression with regard to at least one value extracted 506 from the transformed 504 inbound message. When such a conditional expression is either satisfied or not satisfied, based on the particular routing rule, at least one action to be taken is programmatically defined with such a routing rule, which may include identification of another routing rule to be applied to values extracted 506 from the transformed inbound message or routing to a particular entity.

Some additional embodiments of the method 500 include storing, in a message repository, data representative of the transformed 504 inbound message and adding a representation of the extracted 506 values to the stored transformed 504 inbound message. Such embodiments may further include adding, to the stored transformed 504 inbound message, data representative of routing actions taken based on the at least one applied routing rule and adding, to the stored transformed 504 inbound message, data representative of the transforming 504, 508 and transmitting 512 actions performed with regard to the received 502 inbound message.

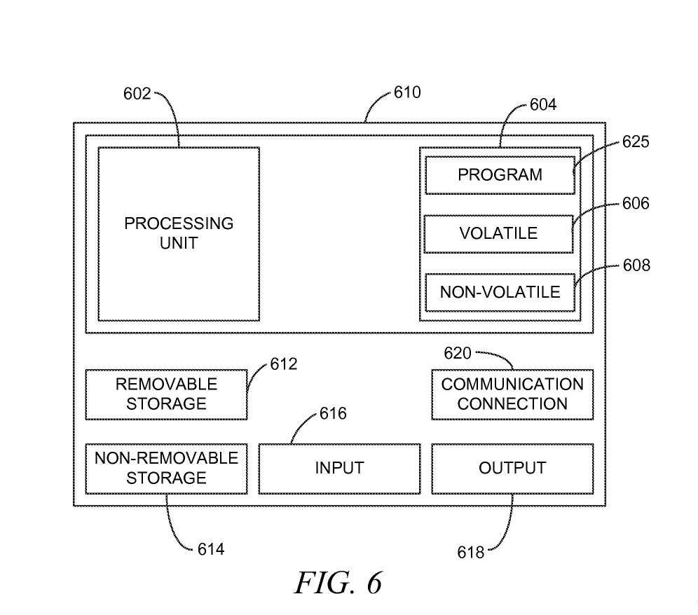

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, or other computing device including the same or similar elements as illustrated and described with regard to FIG. 6. Further, although the various data storage elements are illustrated as part of the computer 610, the storage may also or alternatively include cloud-based storage accessible via a network, such as the Internet.

Returning to the computer 610, memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The input 616 may include one or more of a touchscreen, touchpad, mouse, keyboard, camera, and other input devices. The computer may operate in a networked environment using a communication connection 620 to connect to one or more remote computers, such as database servers, web servers, and other computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network in a messaging hub application, an inbound message from a first system, the inbound message including at least a data payload;
transforming the inbound message from a first format of the first system to a format of the messaging hub application, the format of the messaging hub application including an application portion that includes data identifying the first system as the source of the inbound message, a data portion that includes a form of the data payload, and a log portion to which data representative of actions performed with regard to the inbound message are written;
extracting values from the transformed inbound message;
applying at least one routing rule to the values extracted from the transformed inbound message to identify at a second system to which the transformed inbound message is to be transmitted;
transforming at least the data payload from the format of the messaging hub application to a format of the identified second system; and
transmitting, via the network, an outbound message to the identified second system, the outbound message including at least the data payload.

2. The method of claim 1, further comprising:
storing, in a message repository, data representative of the transformed inbound message;
adding a representation of the extracted values to the stored transformed inbound message;
adding, to the stored transformed inbound message, data representative of routing actions taken based on the at least one applied routing rule; and
adding, to the stored transformed inbound message, data representative of the transforming and transmitting actions performed with regard to the received inbound message.

3. The method of claim 3, wherein the transmitting the outbound message to the identified second system includes:
storing the outbound message to the message repository in association with an identifier of the identified second system;
receiving, via the network, a message request from the identified second system;
retrieving the stored outbound message from the message repository based on the identifier of the second system; and
sending, via the network, the outbound message to the identified second system.

4. The method of claim 1, wherein a routing rule includes:
a conditional expression with regard to at least one value extracted from the transformed inbound message; and
at least one action to be taken when the conditional expression is either satisfied or not satisfied.

5. The method of claim 4, wherein the at least one action includes identification of the second system to which the outbound message is to be transmitted.

6. The method of claim 4, wherein the at least one action includes:
when the conditional expression is satisfied, routing the transformed inbound message to another routing rule;
when the conditional expression is not satisfied, terminating application of the routing rule.

7. The method of claim 1, wherein applying the at least one routing rule includes:
identifying at least two routing rules to apply based on at least one value extracted from the transformed inbound message;
applying each of the at least two identified routing rules to the values extracted from the transformed inbound message, the application of at least one of the two identified routing rules causing application of at least one additional routing rule and resulting in the identification of the second system to which the transformed inbound message it to be transmitted and identification of a third system to which the transformed inbound message is to be transmitted.

8. A non-transitory computer-readable medium, with instructions stored thereon, which when executed by at least one processor of a computing device, causes the computing device to:
receive, via a network, an inbound message in a first format from a source, the inbound message including at least a data payload;
transform the inbound message from the first format to a generic format, the generic format including an application portion that includes data identifying the source of the inbound message, a data portion that includes a form of the data payload, and a log portion to which data representative of actions performed with regard to the inbound message are written;
extract values from the transformed inbound message and adding an extract portion to the transformed inbound message;
apply at least one routing rule to values extracted from the transformed inbound message to identify at least one target to which the transformed inbound message is to be transmitted;
transform at least the data payload from the generic format to a format of each of the at least one identified targets; and
generate and transmit, via the network, an outbound message to each of the at least one targets, each outbound message including at least the data payload transformed into a format of the respective target.

9. The non-transitory computer-readable medium of claim 8, wherein the source and the target are data processing entities.

10. The non-transitory computer-readable medium of claim 9, wherein at least one of the data processing entities is a software system.

11. The non-transitory computer-readable medium of claim 8, wherein each transform is performed according to a data transform model selected from a plurality of data transform models according to a source the inbound message is received from or a target to which an outbound message is to be sent, each transform model including a mapping between data items of the generic format and a format of a respective source or target.

12. The non-transitory computer-readable medium of claim 8, wherein applying the at least one routing rule includes:
identifying at least two routing rules to apply based on at least one value extracted from the transformed inbound message;
applying each of the at least two identified routing rules to at least one value extracted from the transformed inbound message, the application of at least one of the two identified routing rules causing application of at least one additional routing rule and resulting in the identification of each of the at least one targets to which the transformed inbound message it to be transmitted.

13. The non-transitory computer-readable medium of claim 8, wherein execution of the instructions by the at least one processor further causes the computing device to:
store, in a message repository, data representative of the transformed inbound message;
add a representation of the extracted values to the stored transformed inbound message;
add, to the stored transformed inbound message, data representative of routing actions taken based on the at least one applied routing rule; and
add, to the stored transformed inbound message, data representative of the transforming and transmitting actions performed with regard to the received inbound message.

14. The non-transitory computer-readable medium of claim 8, wherein a routing rule includes:
a conditional expression with regard to at least one value extracted from the transformed inbound message; and
at least one action to be taken when the conditional expression is either satisfied or not satisfied.

15. The non-transitory computer-readable medium of claim 14, wherein the at least one action includes identification of another routing rule to be applied to values extracted from the transformed inbound message.

16. A system comprising:
at least one processor;
at least one memory;
at least one network interface; and
an instruction set accessible in the memory and executable by the at least one processor to:
receive, via the network interface, an inbound message in a first format from a source, the inbound message including at least a data payload;
transform the inbound message from the first format to a generic format, the generic format including data identifying the source of the inbound message, the data payload transformed into the generic format, and a log where data representative of actions performed with regard to the inbound message are written;
extract values from the transformed inbound message and adding extract data to the transformed inbound message;
apply at least one routing rule to at least one value of the extract data to identify at least one target to which the transformed inbound message is to be transmitted;
transform at least the data payload from the generic format to a format of each of the at least one identified targets; and
generate and transmit, via the network interface, an outbound message to each of the at least one targets, each outbound message including at least the data payload transformed into a format of the respective target.

17. The system of claim 16, wherein each transform is performed according to a data transform model selected from a plurality of data transform models according to a source the inbound message is received from or a target to which an outbound message is to be sent, each transform model including a mapping between data items of the generic format and a format of a respective source or target.

18. The system of claim 16, wherein applying the at least one routing rule includes:
identifying at least two routing rules to apply based on at least one value extracted from the transformed inbound message;
applying each of the at least two identified routing rules to at least one value extracted from the transformed inbound message, the application of at least one of the two identified routing rules causing application of at least one additional routing rule and resulting in the identification of each of the at least one targets to which the transformed inbound message it to be transmitted.

19. The system of claim 16, wherein the at least one processor, the at least one memory, and the network interface are virtualized computing resources of a computer on which a virtual machine operates, the instruction set executable by the at least one processor within the virtual machine.

20. The non-transitory computer-readable medium of claim 16, wherein a routing rule includes:
a conditional expression with regard to at least one value extracted from the transformed inbound message; and
at least one action to be taken when the conditional expression is either satisfied or not satisfied.
